(19) United States
(12) Patent Application Publication
(10) Pub. No.: US 2026/0185879 A1
(43) Pub. Date: Jul. 2, 2026

(54) FOURIER NOTCH FILTER METHOD AND SYSTEM

(71) Applicant: k-Space Associates, Inc., Dexter, MI (US)

(72) Inventors: Barry D. Wissman, Ann Arbor, MI (US); Andrew Kuhlman, Dexter, MI (US); Darryl Barlett, Dexter, MI (US)

(73) Assignee: k-Space Associates, Inc., Dexter, MI (US)

(21) Appl. No.: 18/855,508

(22) PCT Filed: Jun. 6, 2024
(86) PCT No.: PCT/US2024/032692

§ 371 Date: Oct. 9, 2024

Related U.S. Application Data
(60) Provisional application No. 63/507,823, filed on Jun. 13, 2023.

(51) Int. Cl. G01J 5/58; G01B 11/06; G01N 21/47

(52) U.S. Cl. CPC G01J 5/58; G01B 11/0625; G01N 21/4738; G01B 2210/56

(57) ABSTRACT

A technique for determining the temperature of a semiconductor film during multiple quantum well (MQW) film growth via Metal-Organic Chemical Vapor Deposition (MOCVD). The temperature is determined in real-time as the film grows and increases in thickness. A spectrum based on the diffusely scattered light from the film is produced at each incremental thickness. A reference division is performed on each spectrum to correct for equipment artifacts. The thickness of the film and an optical absorption edge wavelength value are determined from the spectrum. The temperature of the film is determined as a function of the optical absorption edge wavelength and the thickness of the film using the spectrum, a thickness calibration table, and a temperature calibration table. The film temperature is accurately determined to +/−0.25° C. using a Fast Fourier Transform (FFT) and a notch filter.

### CROSS REFERENCE TO RELATED APPLICATIONS

This application claims priority to U.S. Provisional Patent Application Ser. No. 63/507,823 filed Jun. 13, 2023, the entire disclosure of which is hereby incorporated by reference and relied upon.

### BACKGROUND OF THE INVENTION

### Field of the Invention

The invention relates generally to non-contact temperature measurement of thin films as they are deposited onto substrates, and more specifically to improved techniques for determining the band edge wavelength position from scattered light spectra collected from the film in real time.

### Description of Related Art

Semiconductor nanostructures and LEDs are commonly manufactured using any one of several deposition techniques, including chemical vapor deposition processes, molecular beam deposition processes, and sputtering to name a few. Advanced manufacturing processes involving depositing thin films on substrates often depend on the ability to monitor and control the temperature of the substrate with high precision and repeatability.

For many applications, precise temperature measurement during the growth of a thin film on a semiconductor wafer or substrate is critical to the ultimate quality of the finished, coated wafer and in turn to the performance of the opto-electronic devices constructed on the wafer. Variations in substrate temperature, including intra-wafer variations in temperature ultimately affect quality and composition of the layers of material deposited. During the deposition process, the substrate wafer is heated from behind and rotated about a center axis. Typically, a resistance heater positioned in proximity to the wafer provides the heat source for elevating the temperature of the wafer to a predetermined value. Careful control of this heater is required to precisely manage the growth of the thin film on the semiconductor wafer or substrate.

The BandiT™ system from k-Space Associates, Inc., Dexter Michigan, USA (kSA), assignee of the present invention, is a recognized and well-regarded method and apparatus for measuring semiconductor substrate temperature. The kSA BandiT is a non-contact, noninvasive, real-time, absolute wafer temperature sensor. Diffusely scattered light from the wafer is detected to measure the optical absorption edge wavelength. The wavelength of the optical absorption edge (or “band edge wavelength”) enables the temperature of the film to be determined accurately. The kSA BandiT system is described in detail in U.S. Pat. Nos. 7,837,383 and 9,239,265 the entire disclosures of which are incorporated here by reference. An improvement of the kSA BandiT system is represented in U.S. Pat. No. 8,786,841 for applications in which the substrate is optically transparent and thus incapable of producing diffusely scattered light. According to U.S. Pat. No. 8,786,841, the entire disclosure of which is also incorporated by reference, diffusely scattered light reflected off the film is collected, and its spectra analyzed to determine an optical absorption edge as a function of film thickness.

A chemical vapor deposition technique favored in some modern situations is known as Metal-Organic Chemical Vapor Deposition, or MOCVD for short. The MOCVD process must be carried out within a very specific and narrow temperature range. Temperature fluctuations outside the optimal range can impair the quality and composition of the layers of deposited material. In the case of LED devices, this can lead to inconsistent color output. During the MOCVD process, a substrate wafer is heated from behind while being rotated within a controlled chamber.

Despite the many advantages of the kSA BandiT system, including the improved techniques documented in U.S. Pat. No. 8,786,841, new technologies such as multiple quantum well (MQW) film growth via MOCVD require even higher levels of resolution to control the color output of LEDs, and for other objectives. These newer technologies demand even more accuracy to determine the band edge wavelength position for measurement of film temperature.

There is therefore a need in the art for solutions applicable to modern thin film deposition processes that are accurate and fast enough to provide real-time data feedback so that the temperature of the substrate can be controlled with very high precision and repeatability.

### BRIEF SUMMARY OF THE INVENTION

One aspect of the invention provides a method for determining a temperature of a semiconductor film having a measurable optical absorption edge deposited on a substrate having no measurable optical absorption edge. The method comprises the steps of providing the substrate material having no measurable optical absorption edge and depositing the film of a semiconductor material having a measurable optical absorption edge and a measurable thickness on the substrate. The method also includes interacting light with the film deposited on the substrate to produce diffusely scattered light. The method further includes collecting the diffusely scattered light from the film and producing a spectrum indicating optical absorption of the film based on the diffusely scattered light from the film. The method also includes determining the thickness of the film. The method further includes determining the optical absorption edge wavelength of the film, and determining the temperature of the film at the film thickness as a function of the film thickness and the optical absorption edge wavelength. The step of producing a spectrum includes reducing the effects of thin film interference oscillations in the optical absorption edge wavelength using a Fast Fourier Transform (FFT) and a notch filter.

The invention provides highly accurate, real-time measurement of film temperature as a function of film thickness, during deposition on a substrate that has no measurable optical absorption edge. The film temperature is more accurately resolved during the film growth process so that products derived therefrom, such as Light Emitting Diodes (LEDs) can be produced to higher standards. For one example, the color output of LEDs can be held to <1 nm of variation using the principles of this invention.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a graph depicting thin film interference oscillations observed in the below-gap (i.e., wavelengths greater than the optical absorption edge) portion of a processed spectrum;

FIG. 2 is a simplified flow chart summarizing the steps of the present invention;

FIG. 3 is a graph as in FIG. 1 but showing the spectra after making the oscillations periodic in wavelength through a change of variables, in which the wavelength is replaced by the refractive index of the film material(s) divided by the wavelength;

FIG. 4 shows a typical amplitude spectrum resulting from application of a Fast Fourier Transform (FFT);

FIG. 5 is a graph as in FIG. 4 showing identification of the optimum center frequency for the notch filter;

FIG. 6 is a graph as in FIG. 3 after application of the notch filter and after calculating the inverse FFT, in which a reduction in the oscillations can be observed;

FIG. 7 shows the original spectrum of FIG. 1 combined with the filtered and smoothed version using a Savitzky-Golay (SG) digital smoothing filter;

FIG. 8 provides another example of spectra after the FFT-notch filter applications;

FIG. 9 shows side-by-side charts comparing the effect of finding the band edge wavelength across a semiconductor wafer without and with the additional FFT processing of the present invention;

FIG. 10 depicts thin film interference oscillations observed in the below-gap (i.e., wavelengths greater than the optical absorption edge) portion of a processed spectrum, and the set of integer order numbers, mi corresponding the to interference extrema.

FIG. 11 depicts finding a set of integer order numbers, mi by calculating the sequence that minimizes the spread in the set of calculated thickness values; and

FIG. 12 is a flow diagram succinctly summarizing the ancillary technique referred to as Optimizing the Dispersion Curve.

### DETAILED DESCRIPTION OF THE INVENTION

The invention refers to a method, apparatus, and system for determining temperature of a sample including a semiconductor film having a measurable optical absorption edge and a measurable thickness deposited on a substrate having no measurable optical absorption edge. Examples of substrates include but are not limited to wafers of sapphire (Al₂O₃), SiO₂, glass, amorphous SiC, and metals such as thin rolled steel, Cu, Al, Mo, and Ta. Examples of films include semiconductor materials, such as GaN (Gallium Nitride) used as a component of blue and white light emitting diodes (LEDs). Such films can be grown using the known multiple quantum well (MQW) technique via any one of the known processes carried out within a standard deposition chamber. Examples of processes for depositing the film on the substrate include, but are not limited to, chemical vapor deposition processes such as Metal-Organic Vapor Phase Epitaxy (MOVPE) and Metal-Organic Chemical Vapor Deposition (MOCVD), or a molecular deposition process such as Molecular Beam Epitaxy (MBE), sputtering, or other thin-film deposition process.

As is well-documented in U.S. Pat. No. 8,786,841, a controllable heat source inside the deposition chamber heats the substrate and film. A light source mounted outside the deposition chamber produces diffusely scattered light from the sample. The optical absorption edge is also known as the band edge. A spectrometer, such as a solid-state spectrometer or an array spectrometer, produces a spectrum from or based on the diffusely-scattered light from the film. The optical absorption edge wavelength of the film is determined based on the spectrum, which typically involves accounting for the semiconductor material and the thickness of the film.

Many new applications are emerging which require precise real-time monitoring of the thin film properties, such as temperature, during thin film deposition on a substrate formed of a material that does not absorb light and thus has no measurable optical absorption edge. Manufacturers of the LEDs formed of sapphire substrates and GaN films typically require the substrate to maintain a nearly constant temperature, including a 1.0° C. or less deviation, when the film is being deposited on the substrate. In some cases, temperature control must be maintained at +/−0.25° C.

The general dependence of the transmission of light through a semiconductor material is provided by this Equation 1:

$$I ( d ) / I ( 0 ) = exp ( - α d )$$

where d is the thickness of the film, I(d) is the intensity of the diffusely scattered light collected from the film at the film thickness d, I(O) is the intensity of diffusely scattered light collected from the substrate without the film, and a is the absorption coefficient of the material of the film at the band gap energy of the material. The absorption coefficient of the material (α) accounts for the dependence of the optical absorption on the band gap energy of the material, which is temperature dependent. The absorption coefficient (α) is also referred to as α(hv) in the equation given above: α(hv)=ag exp [(hv−E_{g})/E₀].

Equation 1 illustrates that the optical absorption of the film is thickness dependent, and the behavior of the optical absorption is exponential. In applications wherein the substrate has no measurable optical absorption edge wavelength, such as a non-semiconductor, the light is not affected by the substrate. The substrate is typically either transparent (e.g., glass or sapphire) or completely reflective (e.g., steel or other metal). Thus, the light is only affected by the film. And since the film is thin, incremental increases in the film thickness have a significant effect on the measured optical absorption edge wavelength of the film.

Incremental changes in the thickness of the film can be accommodated by determining the optical absorption edge wavelength of the film as a function of the film thickness. The optical absorption edge wavelength and temperature are determined at a time during the manufacturing process when adjustments can be made to the film to correct non-ideal temperatures, which lead to undesirable properties.

The method includes depositing the film of a semiconductor material having a measurable optical absorption edge and a measurable thickness on the substrate, heating the substrate and the film, and interacting light signals with the film deposited on the substrate to produce diffusely scattered light. The method next includes producing a spectrum indicating optical absorption of the film based on the diffusely scattered light from the film. The method also includes determining a thickness of the film, determining the optical absorption edge wavelength of the film, and determining the temperature of the film at the film thickness as a function of the film thickness and the optical absorption edge wavelength.

The first step may include performing a spectra acquisition to correct potential errors due to equipment artifacts, such as a non-uniform response of the Si-based detector used for 350 nm to 600 nm spectroscopy, and non-uniform output light signals of Tungsten-Halogen or Xe lamps in the same wavelength range. These errors could prevent raw diffuse reflectance light signals from yielding a measurable optical absorption edge at the correct wavelength position. When performing the spectra acquisition, it can be assumed the errors are steady state.

The spectra acquisition first includes producing a reference spectrum representing the overall response of the system, i.e., the combination of lamp output signature and detector response, which are both wavelength dependent. The reference spectrum is produced by interacting light with the substrate without the film, for example bare sapphire, and collecting any of the diffusely scattered light in the detector. Next, the spectrometer is used to generate the reference spectrum based on the diffusely scattered light collected from interacting light with the substrate alone. The spectra acquisition concludes by normalizing the reference spectrum.

Each time a raw spectrum is produced based on the diffusely scattered light from the film, the method includes normalizing the raw spectrum and dividing the normalized raw spectrum by the normalized reference spectrum to produce a resultant spectrum. Dividing the raw spectrum by the reference spectrum is performed on every incoming raw spectrum, and is necessary to determine an accurate film thickness, in addition to enhancing the optical absorption edge signature. The resultant spectrum is normalized and used to determine the optical absorption edge wavelength. The resultant spectrum provides a resolvable optical absorption edge wavelength, which is used to determine the temperature or another property of the film.

The spectrum acquisition, which includes creating a normalized reference spectrum, is performed each time a component of the system changes. For example, a view port of the detector can become coated over time, which affects the collected light. The reference spectrum acquisition can be performed one time per run, one time per day, one time per week, or at other time intervals, as needed. Performing the reference spectrum acquisition at every run will typically provide more accurate results.

The spectra of the present method and system, including the reference spectrum, raw spectrum, and resultant spectrum are typically produced by resolving the light signals from the substrate into discrete wavelength components of specific light intensity. The spectra indicate the optical absorption of the film based on the diffusely scattered light from the film. The spectra typically include a plot of the wavelength versus intensity of the light. However, the spectra can provide the optical absorption information in another form, such as a table.

The resultant spectra are used to determine an optical absorption edge wavelength. The optical absorption edge wavelength is the abrupt increase in degree of absorption of electromagnetic radiation of a material at a particular wavelength. The optical absorption edge wavelength is dependent on the specific material, the temperature of the material, and the thickness of the material. The optical absorption edge wavelength can be identified from the spectra; it is the wavelength at which the intensity sharply transitions from very low (i.e., strongly absorbing) to very high (i.e., strongly transmitting). The optical absorption edge wavelength is used to determine the temperature of the substrate.

The method includes producing a wavelength versus temperature calibration table (i.e., temperature calibration table) of a film at a single thickness. The temperature calibration table can also be provided to a user of the method, rather than produced by the user of the method. The temperature calibration table indicates the optical absorption edge wavelength versus temperature at a constant thickness of the film. The temperature calibration table provides subsequent temperature measurements of the film based on the optical absorption edge wavelength obtained from the spectra. The temperature of the film is determined by accounting for the effect of the thickness of the film on the optical absorption edge wavelength, or the dependence of the optical absorption edge wavelength on film thickness.

The thickness of the film can be determined by a variety of methods. In one embodiment of the invention, the thickness of the film is conveniently determined from the spectra produced by the light diffusely scattered from the film and used to determine the optical absorption edge wavelength. The spectra include oscillations at wavelengths above the optical absorption edge region (i.e., below-gap) of the spectra. The oscillations are a result of thin film interference, which is similar to interference rings observable on a thin film of oil. Analysis of the wavelength-dependent peaks and valleys of the oscillations determines the thickness of the film. Equation 2 below can be employed to determine the thickness of the film:

$$d = \frac{1}{2 ( {n}_{1} / {λ}_{1} - {n}_{2} / {λ}_{2} )}$$

wherein d is the thickness of the film, A is the wavelength at a first peak of the oscillations and λ₂ is the is the wavelength at a second peak of the oscillations adjacent to the first peak, or alternatively λ₁ is the wavelength at a first valley of the oscillations and λ₂ is the wavelength at a second valley of the oscillations adjacent to the first valley, n₁ is a predetermined index of refraction dependent on the material of semiconductor at λ₁, and n₂ is a predetermined index of refraction dependent on the material of semiconductor at λ₂. The wavelengths used for λ₁ and λ₂ can be any two successive peaks or any two successive valleys of the oscillations. The oscillations and value obtained for thickness of the film have a non-linear dependence on all layers of the film. The thickness of the film can also be determined using other methods. For example, the thickness can be estimated based on previous measurements of thickness as a function of deposition time or by laser-based reflectivity systems such as the Rate Rat™ product available from k-Space Associates, Inc., Dexter, Michigan USA.

As stated above, the step of determining the optical absorption edge of the film as a function of the film thickness includes accounting for the dependence of the optical absorption of the film on the film thickness. The step of determining the optical absorption edge of the film as a function of the film thickness can also include adjusting a measured optical absorption edge wavelength value of the film obtained from the spectra due to the step of depositing the film of a semiconductor material having a measurable optical absorption edge and a measurable thickness on the substrate. The step of determining the optical absorption edge of the film as a function of the film thickness can also include identifying the semiconductor material of the film and adjusting a measured optical absorption edge wavelength value determined from the spectra based on the semiconductor material and the thickness of the film to obtain an adjusted absorption edge wavelength.

The step of determining the optical absorption edge of the film as a function of the film thickness typically includes using a thickness calibration table. Each semiconductor material has a unique thickness calibration table. The thickness calibration table indicates the optical absorption edge wavelength versus thickness at a constant temperature of the film.

The thickness calibration table can be acquired by growing a film of the semiconductor material at a constant temperature and measuring the optical absorption edge wavelength at each incremental increase in thickness to produce a spectrum for each thickness, such spectra being referred to as the '841 spectra in reference to U.S. Pat. No. 8,786,841. To be clear, the spectra used to determine the band edge temperature of a film in real time according to the teachings of U.S. Pat. No. 8,786,841 are herein referred to as '841 spectra if the spectra are produced according to any teachings found within the entirety of the disclosure of U.S. Pat. No. 8,786,841, including from within its Background section. The thickness calibration table can also be prepared by depositing the film on the substrate at a constant temperature and measuring the optical absorption edge wavelength of the film at the constant temperature and a plurality of thicknesses. Preparing the thickness calibration table at a constant temperature also allows a user to determine the dependence of the optical absorption edge wavelength on the thickness.

The spectra acquisition is performed on each spectrum, as described above. Next, from each of the spectra, a raw optical absorption edge wavelength value is determined for each thickness at the constant temperature. A fit to a polynomial of some order n is performed on the raw optical absorption edge wavelength values to produce the optical absorption edge wavelength versus thickness curve, where n is the order of the polynomial providing the best fit to the data. This nth order polynomial dependence is used to create the thickness calibration table. The thickness calibration table is used as a thickness correction lookup for subsequent temperature measurements. The thickness calibration table illustrates the dependence of the optical absorption edge wavelength on film thickness. The optical absorption edge wavelength increases as the film thickness increases. The thickness calibration table is produced for each unique semiconductor material, as different materials produce different results. The thickness calibration table can also be provided to a user of the method, rather than produced by the user. However, for each unique material, only one thickness calibration table is needed to determine the temperature of the film at various thicknesses and temperatures. The method can include identifying the semiconductor material of the film and providing the thickness calibration table and temperature calibration table for the identified semiconductor material. The temperature of the film at a certain thickness is determined based on the spectra, the thickness calibration table, and the temperature calibration table.

Despite the overall effectiveness of the method, apparatus, and system detailed in U.S. Pat. No. 8,786,841, newer technologies have arisen which necessitate even more accurate determination of the band edge wavelength position for measurement of film temperature. Therefore, this invention includes an improvement method, improved apparatus and improved system to more accurately resolve the film temperature, and in particular during multiple quantum well (MQW) film growth via Metal-Organic Chemical Vapor Deposition (MOCVD). Preliminary testing and prototyping have confirmed that film temperature can be determined to +/−0.25° C. using the principles of the improvement as described below. Resolution accuracies in the neighborhood of +/−0.25° C. are necessary to control the color output of LEDs to <1 nm of variation. This improved technique, which is herein referred to as the Fourier Notch Filter Procedure, enables highly advantageous accurate control of LED color output for manufacturers of LED products.

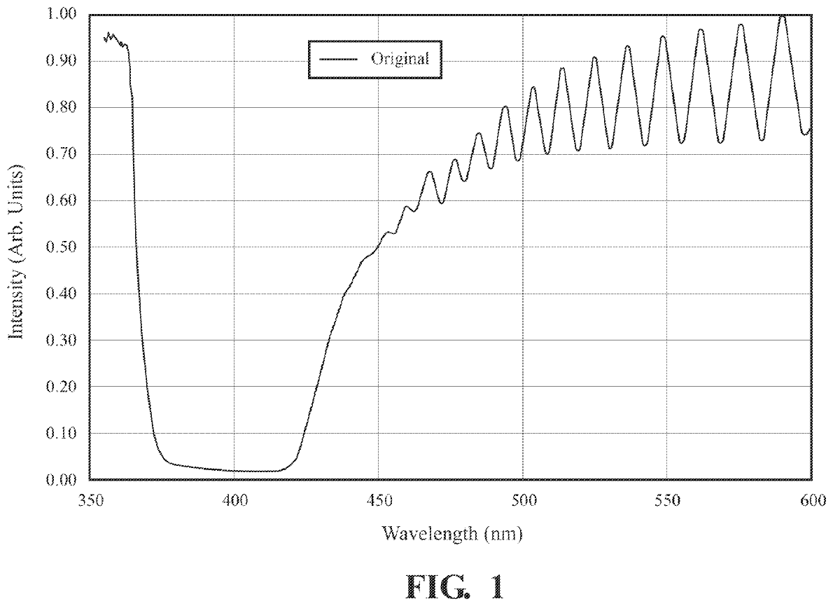

The Fourier Notch Filter Procedure may be used to perform a deconvolution of '841 spectra using a Fast Fourier Transform (FFT) and a notch filter. The Fourier Notch Filter Procedure reduces the intensity of the thin film interference oscillations observed in the below-gap portion of '841 spectra, as these oscillations can negatively impact the determination of the band edge temperature, as well as other important parameters obtained from the analysis of these spectra. Any procedures to be used for this application must be accurate, yet fast enough to be implemented for real-time applications. FIG. 1 provides an example of thin film interference oscillations observed in the below-gap portion of '841 spectra.

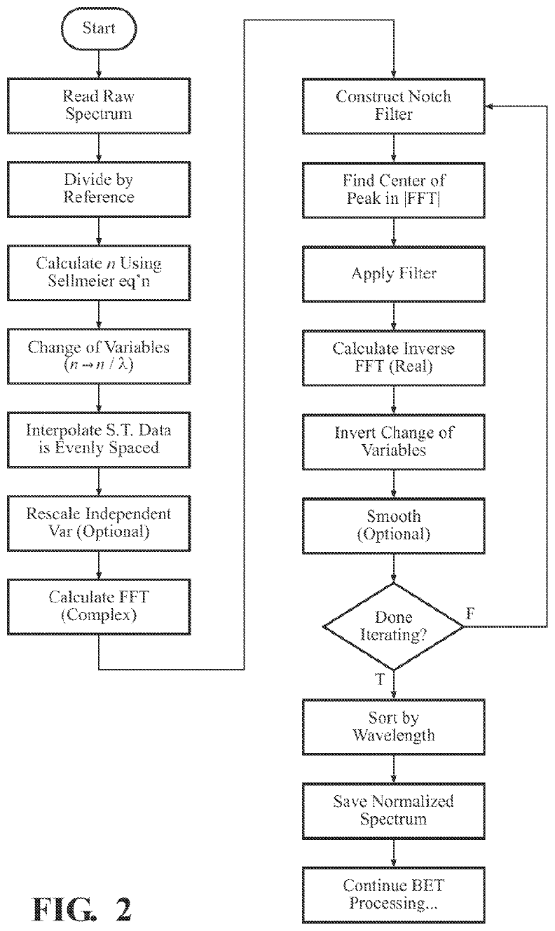

FIG. 2 provides a summary of the steps through which the improvement process is accomplished.

A foundational element of this invention is the recognition that the oscillations can be made periodic through a change of variables. Specifically, the wavelength is replaced by the refractive index of the film material(s) divided by the wavelength, as in the following equation:

$$λ \to {λ}^{′} ≡ \frac{n ( λ )}{λ}$$

Note that the refractive index is also a function of the wavelength. Application of the preceding equation results in the spectrum of FIG. 3.

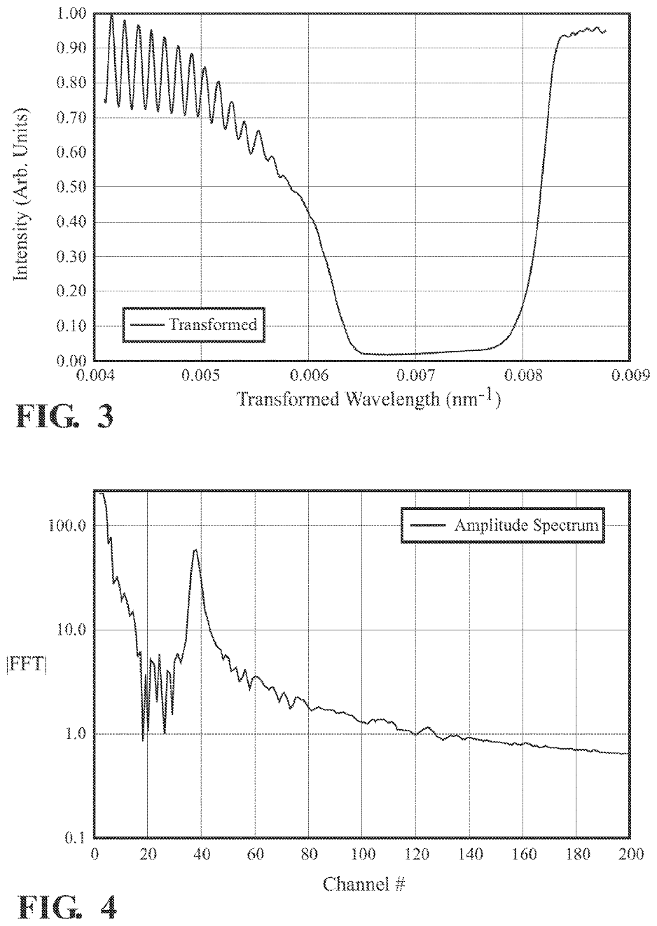

Once the spectrum has been made periodic through a change of variables, its amplitude spectrum can be determined using the FFT. FIG. 4 shows a typical amplitude spectrum resulting from the FFT. The frequency of the oscillations can then be identified and removed using a notch filter. Examples of suitable notch filters include, but are not limited to, an n-Gaussian function. The key parameters for a notch filter include the center wavelength (x₀), the width parameter (Γ), and the shape parameter (n).

$$f ( x ) = {e}^{- {( \frac{x - {x}_{0}}{Γ} )}^{2 n}} , Γ = \frac{FWHM}{2 \sqrt{ln 2}}$$

This functional form is useful because it tends to have a flat top with a Gaussian fall-off at the edges. The larger the value of the shape parameter, the steeper the edges, and therefore the stronger the rejection of the neighboring values.

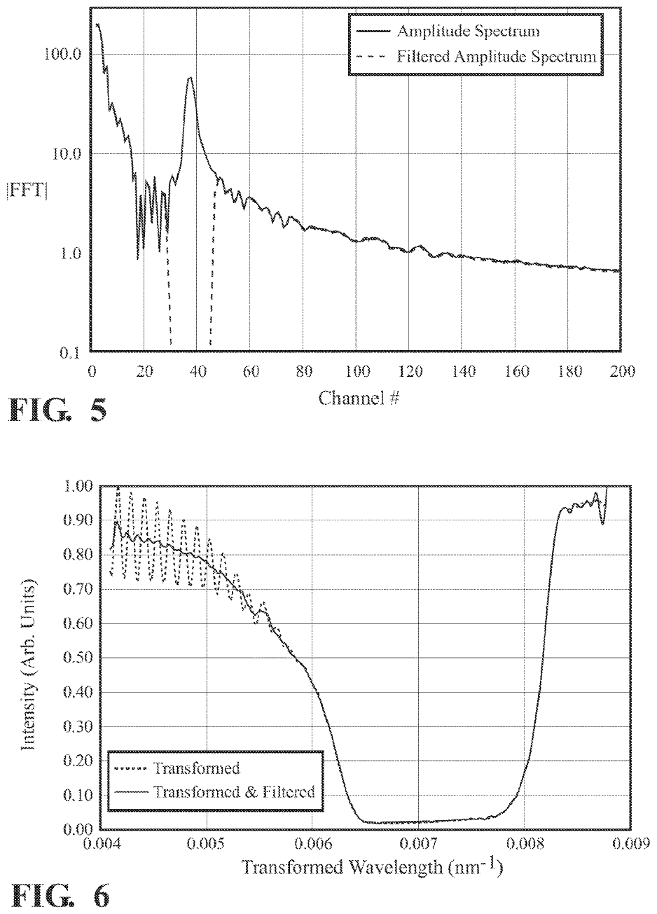

Note that the peak in the amplitude spectrum can be determined by finding the minimum in the second derivative. This is straightforward to accomplish by using a digital smoothing filter, such as the one developed by Savitzky and Golay. (“Smoothing and Differentiation of Data by Simplified Least Squares Procedures”, Analytical Chemistry, pages 1627-1639, Vol. 36, No. 8, 1964.) The Savitzky and Golay (SG) digital smoothing filter is particularly well-suited for this application because it can achieve a high degree of smoothing while still preserving the higher-order moments of the original distribution (i.e., sharp peaks are not flattened as with other such filters). It has the added benefit that since it uses a polynomial to fit the original data, it is then easy to obtain the smoothed derivatives. The ability to conveniently determine the optimum center frequency for the notch filter allows the process to be automated, lending itself to real-time applications. See FIG. 5.

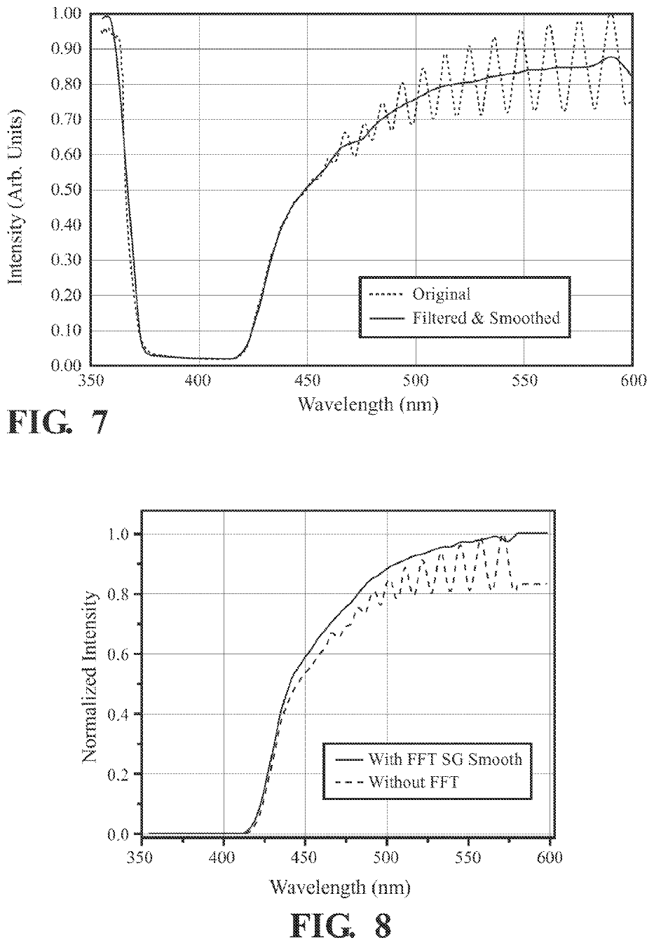

After application of the notch filter, the inverse FFT is calculated. As can be seen from the plot of FIG. 6, the oscillations are greatly diminished. The change of variables is then inverted to transform the filtered spectrum back into a function of the original wavelength. Note that the filtered result can be further improved by an optional application of the Savitzky-Golay (SG) digital smoothing filter mentioned above. FIG. 7 shows the original spectrum, plus the filtered and smoothed version. As can be seen from the plot, the spectrum is now significantly cleaner, facilitating further analysis. Another example of a spectrum after the Fourier notch filter application is shown in FIG. 8.

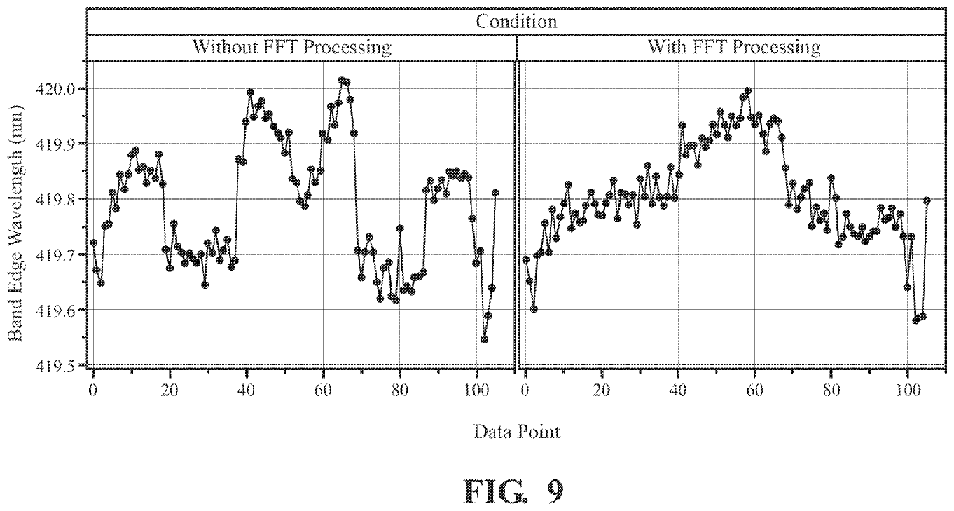

The charts of FIG. 9 show the effect of finding the band edge wavelength across a semiconductor wafer without the additional FFT processing (on left), and by comparison with the additional FFT processing (on right). The leaps in the data without FFT processing are known to be artifacts of the measurement process. The measured band edge position jumps when film interference fringes remain on the band edge. With the FFT processing, the band edge wavelength across the wafer is smooth and continuous.

The invention contemplates an ancillary technique referred to as Optimizing the Dispersion Curve. Optimizing the Dispersion Curve can be applied to improve the performance of the Fourier Notch Filter Procedure. Optimizing the Dispersion Curve comprises improving the accuracy of the dispersion curve used for the notch filter calculation. At any extremum wavelength λᵢ, the optical thickness (i.e., thickness multiplied by the refractive index) is an integral multiple of λ/4:

$${n}_{i} d = {m}_{i} \frac{{λ}_{i}}{4}$$

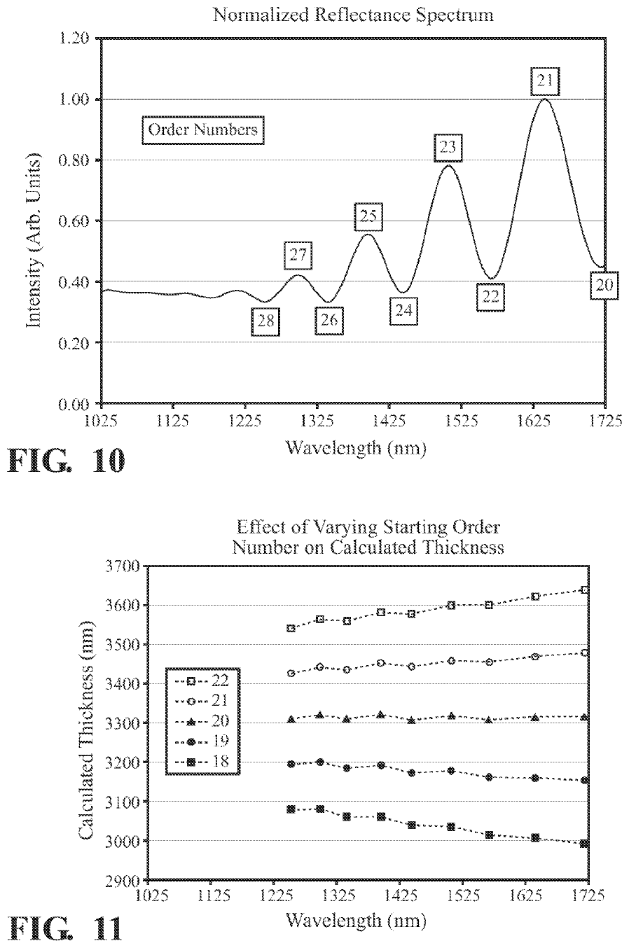

See FIG. 10.

The set of integer order numbers, mi can be found by calculating the sequence that minimizes the spread in the set of calculated thickness values. Note that this requires knowledge of the refractive index nᵢ at the corresponding extremum wavelength λᵢ.

$${d}_{i} = {m}_{i} \frac{{λ}_{i}}{4 {n}_{i}}$$

See FIG. 11.

This result can be used to solve for the optimal index, nᵢ at each extremum:

$${n}_{i} = {m}_{i} \frac{{λ}_{i}}{4 d}$$

Here d is the mean of the set of calculated thickness values.

The resulting index vs. extrema wavelength dispersion curve can be conveniently parameterized by fitting a 3-parameter Sellmeier function of the type used by '841 spectra:

$${n}^{2} ( λ ) = {A}_{0}^{2} + \frac{{A}_{1}^{2}}{{λ}^{2} - {A}_{2}^{2}}$$

Note that there are other possible parameterizations, but this form has the advantage of simplicity, and it works well in the below-gap energy range for many commonly-used semiconductor materials.

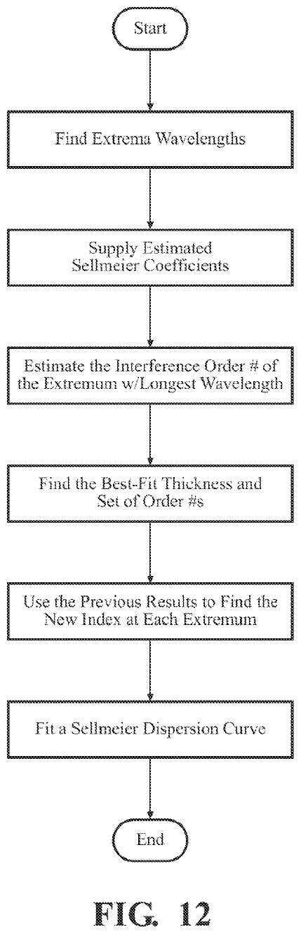

The flow diagram of FIG. 12 offers a succinct summary of the ancillary technique Optimizing the Dispersion Curve. By using this method, the dispersion of the film, n(λ), can be more accurately determined, which in turn yields a more accurate FFT and notch filter removal of the dominant frequency in the spectrum.

Moreover, the invention contemplates an optional method by which the film thickness may be determined. This can be referred to as a Procedure for Estimating Film Thickness from a Pair of Extrema Wavelengths. According to this enhancement, the film thickness is determined from analyzing the wavelength positions of the interference extrema. At any extremum λᵢ, the optical thickness is an integral multiple of λ/4:

$${n}_{i} d = {m}_{i} \frac{{λ}_{i}}{4}$$

Can solve for the film thickness:

$$d = {m}_{i} \frac{{λ}_{i}}{4 {n}_{i}}$$

The following condition holds at any extremum:

$$d = {m}_{i} \frac{{λ}_{i}}{4 {n}_{i}} = {m}_{i - 1} \frac{{λ}_{i - 1}}{4 {n}_{j - 1}} = …$$

In addition, adjacent extrema (e.g., a given peak and its neighboring valley) have integer order numbers that differ by one:

$${m}_{i - 1} - {m}_{i} = 1 = \frac{4 d {n}_{i - 1}}{{λ}_{i - 1}} - \frac{4 d {n}_{i}}{{λ}_{i}}$$

A person of ordinary skill in the art can exploit this to estimate d from any pair of adjacent extrema:

$$\frac{1}{4 d} = \frac{{n}_{i - 1}}{{λ}_{i - 1}} - \frac{{n}_{i}}{{λ}_{i}}$$

$$\frac{1}{d} = 4 ( \frac{{n}_{i - 1}}{{λ}_{i - 1}} - \frac{{n}_{i}}{{λ}_{i}} )$$

Here the wavelength and index values used can correspond to any peak in the oscillations, and its preceding or successive valley.

By looking at the variation in d from the calculation of all adjacent extrema, the person of ordinary skill in the art can produce an estimate of the error or “goodness” in the thickness measurement. Given the above result, one can also estimate the interference order of the extremum with the longest wavelength:

$${m}_{i} = \frac{4 {n}_{i} d}{{λ}_{i}}$$

In summation, this present invention is an improvement to the teachings of U.S. Pat. No. 8,786,841 that enable film temperature to be more accurately resolved during multiple quantum well (MQW) film growth via Metal-Organic Chemical Vapor Deposition (MOCVD) to +/−0.25° C. Such high levels of resolution are considered necessary to control the color output of LEDs to <1 nm of variation, a technology that has very high commercial value in connection with controlling LED color output.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A method for determining temperature of a semiconductor film having a measurable optical absorption edge deposited on a substrate material having no measurable optical absorption edge, said method comprising the steps of:
a) providing a substrate of material having no measurable optical absorption edge,
b) depositing a film of a semiconductor material having a measurable optical absorption edge and a measurable thickness on the substrate,
c) interacting light with the film deposited on the substrate to produce diffusely scattered light,
d) collecting the diffusely scattered light from the film,
e) producing a spectrum indicating optical absorption of the film based on the diffusely scattered light from the film,
f) determining a thickness of the film,
g) determining the optical absorption edge wavelength of the film based on the spectrum, and
h) determining a temperature of the film at the film thickness as a function of the film thickness and the optical absorption edge wavelength,
i) wherein said step of producing a spectrum includes reducing the intensity of thin film interference oscillations in the optical absorption edge wavelength using a Fast Fourier Transform (FFT) and a notch filter.

2. The method of claim 1 wherein the notch filter of said step i) includes an n-Gaussian function.

3. The method of claim 1 wherein the notch filter of said step i) includes a function
$$f ( x ) = {e}^{- {( \frac{x - {x}_{0}}{Γ} )}^{2 n}} , Γ = \frac{FWHM}{2 \sqrt{ln 2}}$$
wherein x₀ is the center wavelength, Γ is the width parameter, and n is the shape parameter.

4. The method of claim 1 wherein the notch filter of said step i) includes determining a peak in the amplitude spectrum by finding the minimum in the second derivative.

5. The method of claim 1 wherein the notch filter of said step i) includes determining an optimum center frequency using a digital smoothing filter.

6. The method of claim 1 further including the step of calculating the inverse FFT after applying the notch filter of said step i).

7. The method of claim 6 further including applying a digital smoothing filter after calculating the inverse FFT.

8. The method of claim 1 wherein the notch filter of said step i) includes developing a dispersion curve, further including the step of optimizing the dispersion curve by determining a set of integer order numbers.

9. The method of claim 8 wherein said step of determining a set of integer order numbers includes calculating a sequence that minimizes the spread in a set of calculated thickness values.

10. The method of claim 1 wherein said step f) determining the film thickness includes estimating film thickness from a pair of extrema wavelengths.

11. The method of claim 10 wherein estimating film thickness includes analyzing the wavelength positions of the interference extrema according to the formula:
$${n}_{i} d = {m}_{i} \frac{{λ}_{i}}{4}$$
such that at any extremum λᵢ, the optical thickness is an integral multiple of λ/4.

12. The method of claim 11, further including solving for the film thickness according to the formula:
$$d = {m}_{i} \frac{{λ}_{i}}{4 {n}_{i}} .$$

13. The method of claim 12, further including estimating d from any pair of adjacent extrema according to the formula:
$$\frac{1}{4 d} = \frac{{n}_{i - 1}}{{λ}_{i - 1}} - \frac{{n}_{i}}{{λ}_{i}}$$
$$\frac{1}{d} = 4 ( \frac{{n}_{i - 1}}{{λ}_{i - 1}} - \frac{{n}_{i}}{{λ}_{i}} ) .$$

14. The method of claim 13, further including producing an estimate of the error in the film thickness measurement as a function of the variation in d from the calculation of all adjacent extrema.

15. The method of claim 14, further including estimating the interference order of the extremum with the longest wavelength according to the formula:
$${m}_{i} = \frac{4 {n}_{i} d}{{λ}_{i}} .$$

16. The method of claim 1 including re-determining the temperature of the film at incremental thicknesses to detect changes in temperature due to said step b).

17. The method of claim 1 including providing a temperature calibration table indicating optical absorption edge wavelength versus temperature at a constant thickness of the film, providing a thickness calibration table indicating optical absorption edge wavelength versus thickness at a constant temperature of the film, and
wherein said step h) includes determining a difference between an optical absorption edge wavelength at the thickness determined by said step f) and the optical absorption edge wavelength at the thickness of the temperature calibration table using the thickness calibration table to obtain a wavelength difference,
subtracting the wavelength difference from the optical absorption edge wavelength determined by said step g) to provide an adjusted optical absorption wavelength value, and
using the adjusted optical absorption wavelength value to determine the temperature of the film at the thickness determined by said step f).

18. The method of claim 1 wherein said step g) includes accounting for the semiconductor material and the thickness of the film.

19. The method of claim 1 wherein said step b) comprises Metal-Organic Chemical Vapor Deposition (MOCVD).

20. A method for determining temperature of a semiconductor film during multiple quantum well (MQW) film growth, the semiconductor film having a measurable optical absorption edge deposited on a substrate material having no measurable optical absorption edge, said method comprising the steps of:
a) providing a substrate of material having no measurable optical absorption edge,
b) depositing a film of a semiconductor material having a measurable optical absorption edge and a measurable thickness on the substrate by Metal-Organic Chemical Vapor Deposition (MOCVD),
c) interacting light with the film deposited on the substrate to produce diffusely scattered light,
d) collecting the diffusely scattered light from the film,
e) producing a spectrum indicating optical absorption of the film based on the diffusely scattered light from the film,
f) determining a thickness of the film,
g) determining the optical absorption edge wavelength of the film based on the spectrum, and
h) determining a temperature of the film at the film thickness as a function of the film thickness and the optical absorption edge wavelength,
i) wherein said step of producing a spectrum includes reducing the intensity of thin film interference oscillations in the optical absorption edge wavelength using a Fast Fourier Transform (FFT) and a notch filter.
